(19) United States
(12) Patent Application Publication
(10) Pub. No.: US 2007/0159821 A1
(43) Pub. Date: Jul. 12, 2007

(54) Decorative Lighting Unit for a String-Lights

(75) Inventors: Xuliang Li, Dongguan City (CN); Guoqiang Deng, Dongguan City (CN); Shaozhen Wu, Dongguan City (CN)

Correspondence Address: GLOBAL IP SERVICES, 2462 ROCK ST., APT. 6, MOUNTAIN VIEW, CA, 94043, US

(73) Assignee: Xuliang Li, Dongguan City (CN)

(21) Appl. No.: 11/306,725

(22) Filed: Jan. 9, 2006

(51) Int. Cl. F21S 13/14

(52) U.S. Cl. 362/252

(57) ABSTRACT

A decorative lighting unit for a string-lights, especially for a LED string-lights, comprises: a LED-lamp and a plurality of connection leads. Said decorative lighting unit further comprises a leg-locating block, a LED-lamp holder and a transparent plate with decorative patterns formed therein. Said LED-lamp, transparent plate and leg-locating block are assembled together. Said LED-lamp comprises a lamp head and lamp legs. Said lamp legs pass through the leg-locating block and are inserted into the LED-lamp holder. Said lamp legs are electrically coupled to the connection leads. Compared with conventional technology, the LED string-lights incorporated with the decorative lighting units of the invention make the patterns formed on the plate glowing and thus bring comfortable effect, since the light radiated from the LED-lamp is directed to the transparent plate.

### FIELD OF THE INVENTION

The present invention relates to a decorative lighting unit used for a string-lights, and more particularly, to a decorative lighting unit used for a LED (light-emitting diode) string-lights.

### BACKGROUND OF THE INVENTION

With the gradual development of city lighting project, string-lights are widely utilized. Previously normal single color bulbs were used in a string-lights and which were coated with different colors on their surface to render various colors. However, considering factors such as energy saving and usage life, recent string-lights tend to take LEDs (light-emitting diode) as its lighting source, and the string-lights with the LEDs are called as LED string-lights. The decorative lighting unit of conventional LED string-lights is constructed of only naked LED bulbs or LED bulbs with decoration covered on its surface. Accordingly, decorative effect of the conventional LED string-lights is a little colorless and unpopular for city night beautification, and thus the wide utilization of LED string-lights is limited. Furthermore, the usage life of lighting source will be shortened rapidly due to expose the lighting source directly to an opened air environment.

### SUMMARY OF THE INVENTION

One object of the invention is to overcome the drawbacks of the prior art, change the structure of decorative lighting unit of conventional LED string-lights and provide a decorative lighting unit for LED string-lights which have more suitable structure and can generate more pleasing decorative effect.

For achieving above-mentioned object, the decorative lighting unit of the invention comprises:a LED-lamp and a plurality of connection leads. Said decorative lighting unit further comprises a leg-locating block, a LED-lamp holder and a transparent plate with decorative patterns formed therein. Said LED-lamp, transparent plate and leg-locating block are assembled together. Said LED-lamp comprises a lamp head and lamp legs. Said lamp legs pass through the leg-locating block and are inserted into the LED-lamp holder. Said lamp legs are electrically coupled to the connection leads.

Compared with conventional technology, the LED string-lights incorporated with the decorative lighting units of the invention make the patterns formed on the plate glowing and thus bring comfortable effect, since the light radiated from the LED-lamp is directed to the transparent plate. Additionally, as the LED-lamp is enclosed in the decorative lighting unit completely, exposure of the LED-lamp to opened air is prevented from happening and usage life thereof is extended effectively.

The present invention will become more obvious from the following description when taken in connection with the accompanying drawings, which show, for purposes of illustration only, preferred embodiments in accordance with the present invention. In the drawings:

### BRIEF DESCRIPTION OF THE DRAWINGS

FIG. 1 is an exploded perspective view of the present invention;

FIG. 2 is a schematic, partial, cross-sectional view of the prevent invention to show an interior structure thereof;

FIG. 3 is a perspective view of the present invention in an assembled state; and

FIG. 4 schematically shows an application of the present invention as a string-lights.

### DETAILED DESCRIPTION OF THE INVENTION

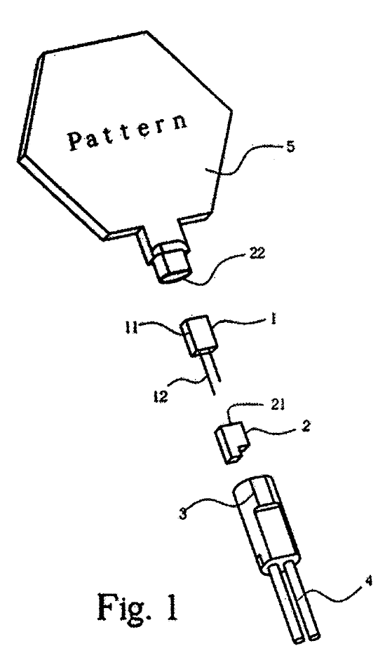

Referring to FIG. 1, the decorative lighting unit 9 of the invention used for a string-lights comprises a LED-lamp 1, a leg-locating block 2, a LED-lamp holder 3, a plurality of connection leads 4 and a piece of transparent plate 5 with decorative patterns formed thereon. The LED-lamp 1 has a lamp head 11 and two lamp legs 12 which are parallel and have a different length with each other. Correspondingly, the leg-locating block 2 has a pair of through holes 21 formed therein through which the lamp legs 12 go. The transparent plate 5 has a cavity 22 for fitly accommodating the lamp head 11 of the LED-lamp 1.

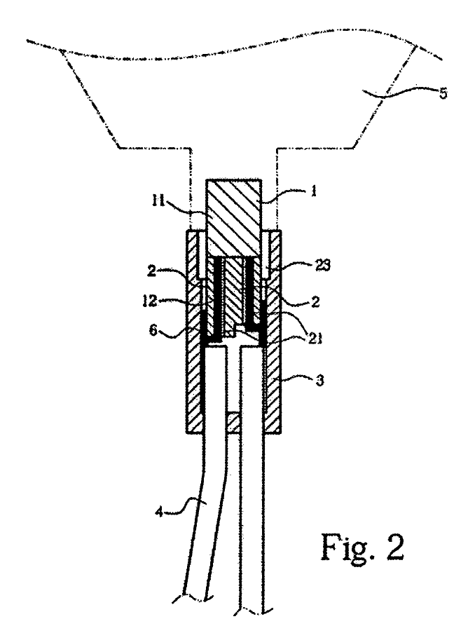

Referring to FIG. 2, the LED-lamp holder 3 has a receiving-cavity 23 formed on one end thereof to receive the LED-lamp 1 and leg-locating block 2. The connection leads 4 are inserted into the LED-lamp holder 3 from the other end thereof and connected to the LED-lamp holder 3.

Still referring to FIG. 2, the lamp head 11 of the LED-lamp 1 is received within the cavity 22 of the transparent plate 5, while the lamp legs 12 of the LED-lamp 1 pass through the through holes 21 of the leg-locating block 2 and then bent outwardly, thereby form a combination of the LED-lamp 1, transparent plate 5 and leg-locating block 2.

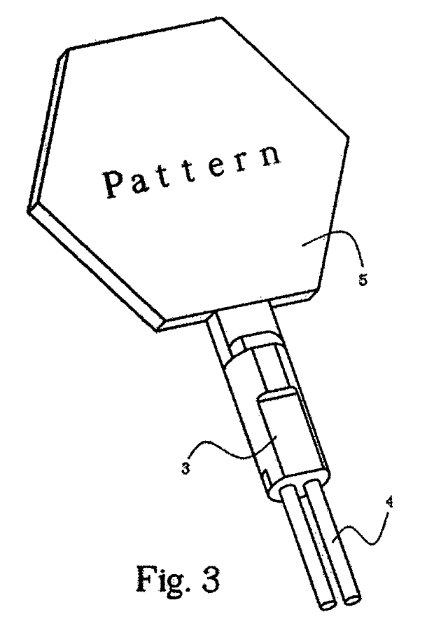

Now referring to FIGS. 2 and 3, next, the combination is inserted into the receiving-cavity 23 of the LED-lamp holder 3 and the lamp legs 12 are electrically coupled to the connection leads 4.

In the embodiment of the invention, for achieving convenient and stable electrical connection between the lamp legs 12 and connection leads 4, the connection leads 4 are electrically coupled to a plurality of conductive terminals 6 in advance, these conductive terminals 6 be fixedly disposed in the LED-lamp holder 3 and exposed on side walls of the receiving-cavity 23 of the LED-lamp holder 3, thus the electrical connection between the lamp legs 12 and connection leads 4 is realized by contacting between the lamp legs 12 and conductive terminals 6.

When the LED-lamp 1 is lighted by power, the light radiated from the LED-lamp 1 spreads in the transparent plate 5 and comes out, and this makes the patterns formed in the transparent plate 5 glowing.

In this embodiment, the manner in which the lamp legs 12 are fixed to the transparent plate 5, the leg-locating block 2 and the transparent plate 5 are fixed to the LED-lamp holder 3, the fixing way may take direct contact engagement connecting method or other connecting method (such as engagement of a detent and a detent slot or adhesive method), and the detailed description of these connecting methods is omitted here from as these connecting methods are common knowledge.

In this embodiment described above, the transparent plate 5 may have different thickness and various shapes. Also the transparent plate 5 may have patterns printed or engraved thereon. In addition, the LED-lamp 1 may be a single-color LED-lamp or double-color LED-lamp with two legs that may be controlled by a special controller to generate color-changing effect.

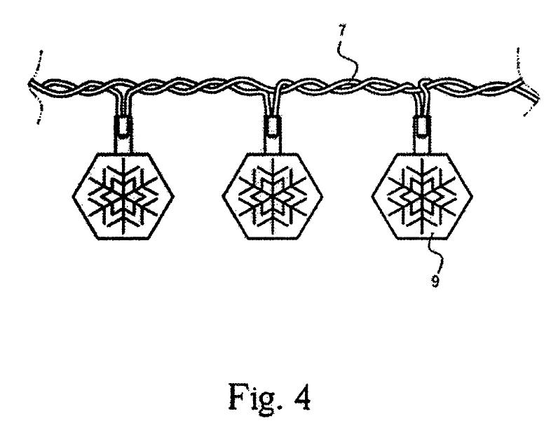

Now referring to FIG. 4, the conventional decorative lighting units of a conventional LED string-lights 7 may be replaced by the decorative lighting units 9 of the invention, therefore, the LED string-lights incorporated with the decorative lighting units 9 of the invention may produce better decorative effect.

Summarily, compared with conventional technology, the invention has many advantages:

By incorporating decorative lighting units of the invention with a LED string-lights, the light radiated from the LED-lamp is directed to the transparent plate, thereby makes the patterns formed on the plate glowing and thus brings comfortable effect. Additionally, since the LED-lamp is enclosed in the decorative lighting unit completely, exposure of the LED-lamp to opened air is prevented from happening and usage life thereof is extended effectively.

What is claimed is:

1. A decorative lighting unit for a string-lights, comprising:
a LED-lamp; and a plurality of connection leads, wherein further comprising a leg-locating block, a LED-lamp holder and a transparent plate with decorative patterns formed therein, said LED-lamp, said transparent plate and said leg-locating block be assembled together, said LED-lamp comprising a lamp head and lamp legs, said lamp legs passing through said leg-locating block and be inserted into the LED-lamp holder, and be electrically coupled to said connection leads.

2. The decorative lighting unit for a string-lights as claimed in claim 1, wherein said LED-lamp holder has a receiving cavity formed on one end thereof for accommodating said LED-lamp and said leg-locating block therein, said connection leads are inserted into the other end of said LED-lamp holder.

3. The decorative lighting unit for a string-lights as claimed in claim 2, wherein said connection leads are electrically connected conductive terminals in advance, said conductive terminals be disposed fixedly into said LED-lamp holder and exposed on the sidewalls of the receiving cavity of said LED-lamp holder, and said lamp legs of the LED-lamp contacting said conductive terminals.

4. The decorative lighting unit for a string-lights as claimed in claim 1 wherein said leg-locating block has holes defined therein, through and over which said lamp legs of the LED-lamp pass.

5. The decorative lighting unit for a string-lights as claimed in claim 3, wherein said leg-locating block has holes defined therein, through and over which said lamp legs of the LED-lamp pass.

6. The decorative lighting unit for a string-lights as claimed in claim 4, wherein said lamp legs of said LED-lamp pass through and over the holes of said leg-locating block and bend outwardly.

7. The decorative lighting unit for a string-lights as claimed in claim 5, wherein said lamp legs of said LED-lamp pass through and over the holes of said leg-locating block and bend outwardly.

8. The decorative lighting unit for a string-lights as claimed in claim 1, wherein said transparent plate has a cavity formed therein for receiving the lamp head of said LED-lamp.

9. The decorative lighting unit for a string-lights as claimed in claim 3, wherein said transparent plate has a cavity formed therein for receiving the lamp head of said LED-lamp.
